(19) United States
(12) Patent Application Publication
(10) Pub. No.: US 2004/0141021 A1
(43) Pub. Date: Jul. 22, 2004

(54) Image recording apparatus and image recording method

(76) Inventors: Junichi Yamamoto, Wakayama-shi (JP); Masaaki Tsuji, Wakayama-shi (JP)

Correspondence Address: SMITH PATENT OFFICE, 1901 PENNSYLVANIA AVENUE N W, SUITE 200, WASHINGTON, DC, 20006

(21) Appl. No.: 10/727,047

(22) Filed: Dec. 4, 2003

(30) Foreign Application Priority Data
Dec. 4, 2002 (JP) 2002-352531

(51) Int. Cl. B41J 29/38

(52) U.S. Cl. 347/16

(57) ABSTRACT

An ink-jet printer comprises two pairs of conveyance rollers that pinch a paper and, in this condition, convey the paper to a print region confronting printing heads. When printing is performed on a wide paper, the paper is pinched with both of the two pairs of conveyance rollers. A sensor is attached to a carriage that holds the printing heads and is movable forward perpendicularly to a paper conveyance direction. The sensor detects a right edge of the paper, and feeds this detection signal to a misalignment amount calculator. The misalignment amount calculator calculates a misalignment amount of the paper from a given conveyance area that is associated with a paper size. An individual controller individually controls the respective pairs of conveyance rollers such that the misalignment amount may become smaller.

### BACKGROUND OF THE INVENTION

1. Field of the Invention

The present invention relates to an image recording apparatus that records an image on a recording medium, and also to an image recording method.

2. Description of Related Art

Some ink-jet printers, which are used as an image recording apparatus, convey a paper to a print region confronting a printing head by means of a pair of conveyance rollers disposed upstream of the printing head in a paper conveyance direction (see Japanese Patent Laid-Open No. 2001-277543). The pair of conveyance rollers includes a drive roller that contacts with a lower face of the paper, and a press roller that contacts with an upper face of the paper and presses against the drive roller. Each of the rollers has an axis perpendicular to the paper conveyance direction, and has a length somewhat larger than that of the print region. The paper is, as pinched with the drive roller and the press roller of the pair of conveyance rollers, conveyed downstream in the conveyance direction in accordance with rotation of the drive roller.

As this type of printer, there is known a printer in which a paper magazine contains a roll portion formed by rolling a long paper, the paper unwound from the roll portion is conveyed to a print region by means of a pair of conveyance rollers, and, in the print region, a printing head ejects ink while reciprocating perpendicularly to a paper conveyance direction, to thereby perform printing. The paper is kept stopped during reciprocations of the printing head, and conveyed intermittently by a predetermined feeding amount when the printing head is in a resting state before starting a forward or backward movement.

In this type of printer, sometimes, the paper magazine may contain two roll portions, and two relatively narrow papers unwound from the respective roll portions may be arranged in parallel and subjected to printing simultaneously, to thereby improve processing performance of the printer. In this case, conveyance areas of the respective two papers are generally arranged symmetrically with respect to an axial center of the pair of conveyance rollers. However, when only one of the two papers is to undergo a printing operation, the pair of conveyance rollers has to pinch and convey the one paper disposed asymmetrically with respect to the axial center of the pair of conveyance rollers. This may, at a high possibility, cause the paper to misalign from a given conveyance area along with a progress of conveyance by the pair of conveyance rollers.

Here, a “conveyance area” of a paper is a band-like area having a certain fixed width and formed along a paper conveyance direction. The conveyance area is determined depending on a position of printing. That is, appropriate printing can be realized by accurately arranging a paper in a given conveyance area.

A “misalignment” means a displacement in a direction perpendicular to a paper conveyance direction, or an inclination with respect to a paper conveyance direction.

In order to avoid a misalignment of a paper, thus, it is conceivable that two pairs of conveyance rollers corresponding to respective two papers are disposed in parallel with an axial center of each pair of conveyance rollers set as a widthwise center of each conveyance area. When such a printer in which two pairs of conveyance rollers are disposed in parallel is to perform printing on a paper with a width thereof extending over the two pairs of conveyance rollers (e.g., a wide and long paper), the paper is pinched with and conveyed by two pairs of conveyance rollers. Accordingly, the two pairs of conveyance rollers need to be synchronized with each other.

However, an attempt to synchronize the two pairs of conveyance rollers may cause respective conveyance powers to be unbalanced. This is, for example, because an individual difference between drive rollers or press rollers constituting the pairs of conveyance rollers causes a difference, between the drive rollers or the press rollers, in paper feeding amount per one rotation thereof, or because an individual difference between motors for driving the respective drive rollers causes a difference, between the rollers, in rotational frequency, etc., with respect to rotations of the motors. The unbalance between conveyance powers may cause the paper to misalign from a given conveyance area.

In particular, when a servomotor, which is capable of relatively high accuracy in feeding, is adopted as a motor for driving the drive roller constituting the pair of conveyance rollers, since a servomotor is easily affected by a load of a paper, respective conveyance powers of the two pairs of conveyance rollers result in differences. Accordingly, the paper receives nonuniform power and thereby misaligns from a given conveyance area. In addition, when printing is performed onto a long paper, once the paper misaligns, an amount of misalignment (particularly a displacement in a direction perpendicular to a paper conveyance direction) becomes larger as a rear end of the paper approaches.

If a paper misaligns from a given conveyance area, ink cannot land on a desired position and there arises a phenomenon, such as banding, which causes deterioration in printing quality. Moreover, since there is a problem that a misalignment of a paper causes ink to land outside the paper, it becomes difficult to enlarge a print region. For margin-free printing, particularly, in order to prevent ink from adhering onto a paper conveyance surface of a platen for supporting a paper, the platen is provided with ink receiving portions for receiving ink ejected outside paper edges in a direction perpendicular to a paper conveyance direction. However, by a misalignment of the paper, the paper edges are located at positions not corresponding to the ink receiving portions, and thus ink may adhere onto the paper conveyance surface of the platen.

### SUMMARY OF THE INVENTION

An object of the present invention is to provide an image recording apparatus and an image recording method capable of, even when a single paper as a recording medium is conveyed by plural pairs of conveyance rollers as conveyance power suppliers, effectively restraining the paper as a recording medium from misaligning from a given conveyance area.

According to a first aspect of the present invention, there is provided an image recording apparatus comprising: an image recorder that records an image on a recording medium; a conveyance mechanism having plural conveyance power suppliers each supplying a conveyance power independent from each other to a recording medium, the conveyance mechanism being capable of conveying, to a region confronting the image recorder, a recording medium with a width thereof extending over the plural conveyance power suppliers; a sensor that detects a recording medium being conveyed by the conveyance mechanism; a misalignment amount calculator that calculates, based on a detection signal fed from the sensor, a misalignment amount of a recording medium from a given conveyance area; and an individual controller that individually controls the respective plural conveyance power suppliers such that the misalignment amount may become smaller.

According to a second aspect of the present invention, there is provided an image recording method comprising the steps of: conveying a paper to a region confronting an image recorder that records image on a recording medium, by means of plural conveyance power suppliers each supplying a conveyance power independent form each other to a recording medium; detecting, with a sensor, a recording medium in a region confronting the image recorder; calculating, based on a detection signal fed from the sensor, a misalignment amount of a recording medium from a given conveyance area; intermittently conveying a recording medium as the plural conveyance power suppliers are individually controlled such that the misalignment amount may become smaller; and recording an image, by means of the image recorder, on a recording medium having conveyed by the plural conveyance power suppliers.

According to the foregoing first and second aspects, the sensor detects the recording medium, the misalignment amount calculator calculates, based on this detection signal, the misalignment amount of the recording medium from the given conveyance area, and the individual controller individually controls the respective plural conveyance power suppliers such that the misalignment amount may become smaller. Consequently, even when a single recording medium is conveyed by plural conveyance power suppliers, a misalignment from a given conveyance area can effectively be restrained. This restraint on misalignment can relieve at least one of the various problems as mentioned above.

### BRIEF DESCRIPTION OF THE DRAWINGS

Other and further objects, features and advantages of the invention will appear more fully from the following description taken in connection with the accompanying drawings in which:

FIG. 1 schematically illustrates a construction of an ink-jet printer according to an embodiment of the present invention;

FIG. 2 is a partial top view of the ink-jet printer of FIG. 1;

FIG. 3 schematically illustrates a construction of a drive mechanism of a carriage shown in FIG. 1;

FIG. 4 is a block diagram showing a control system of the ink-jet printer of FIG. 1;

FIG. 5 schematically illustrates a construction in the vicinity of an ink-jet printing unit shown in FIG. 1 in a case where printing is performed on a wide and long paper;

FIG. 6 is a flow chart showing an example of a method for printing on a wide and long paper using the ink-jet printer of FIG. 1;

FIGS. 7 to 13 are top views chronologically showing an operation of the ink-jet printer of FIG. 1 as an example in a case where printing is performed on a wide and long paper;

FIG. 14 is a partial enlarged view for explaining an example of a method for calculating a misalignment amount of a paper from a given conveyance area; and

FIG. 15 illustrates a modification of a sensor attached to the carriage.

### DESCRIPTION OF THE PREFERRED EMBODIMENTS

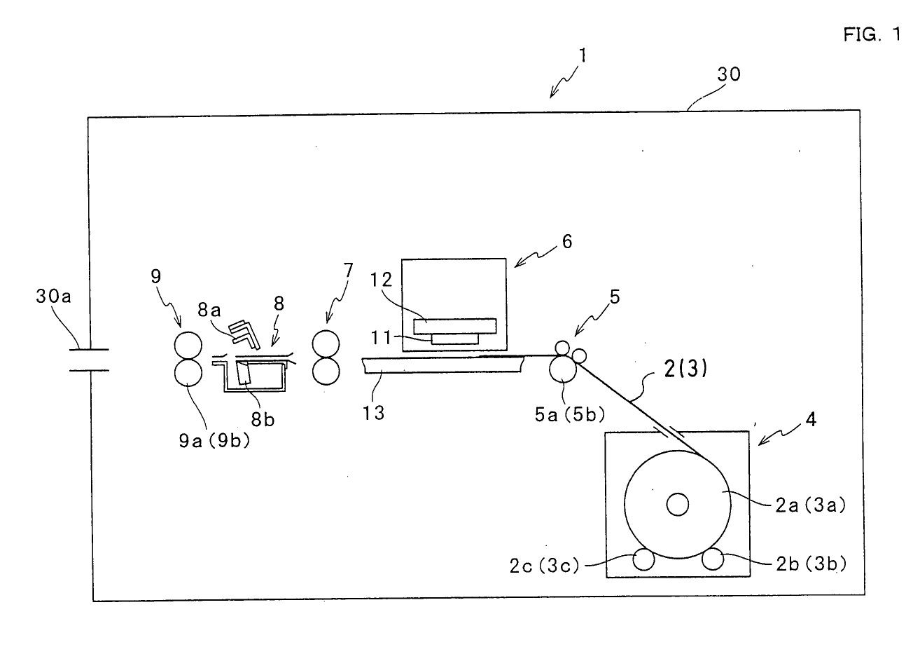

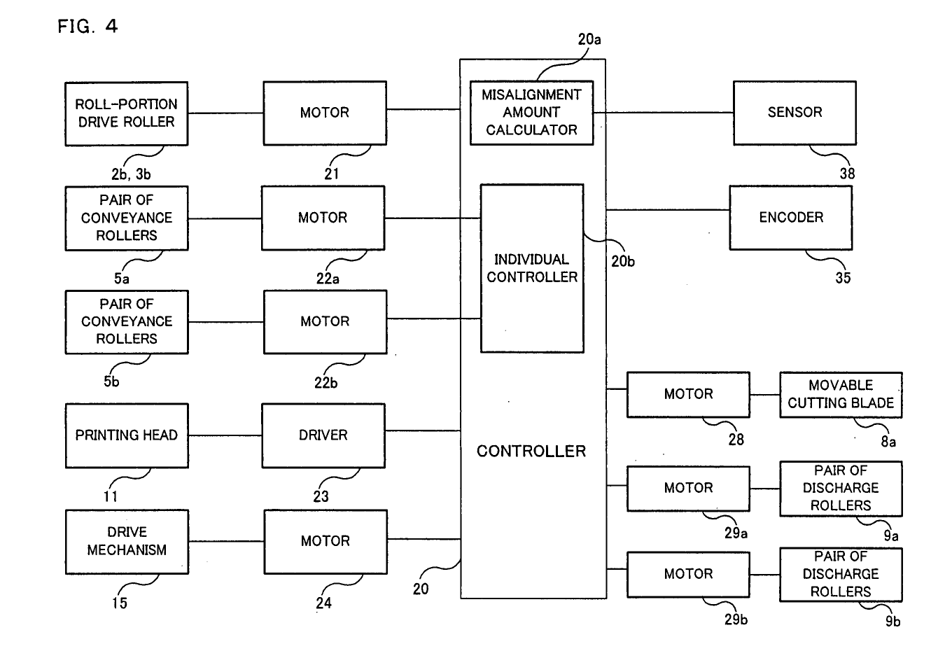

An ink-jet printer 1 as an image recording apparatus illustrated in FIG. 1 has a substantially rectangular parallelepiped casing 30. The casing 30 includes therein a paper magazine 4 as a roll-portion container, an advance roller unit 5 as a conveyance mechanism, an ink-jet printing unit 6, a press roller unit 7, a cutting unit 8, and a discharge roller unit 9 in this order from an upperstream side in a paper conveyance direction. A controller 20 (see FIG. 4) disposed within the casing 30 controls an operation of each part of the ink-jet printer 1.

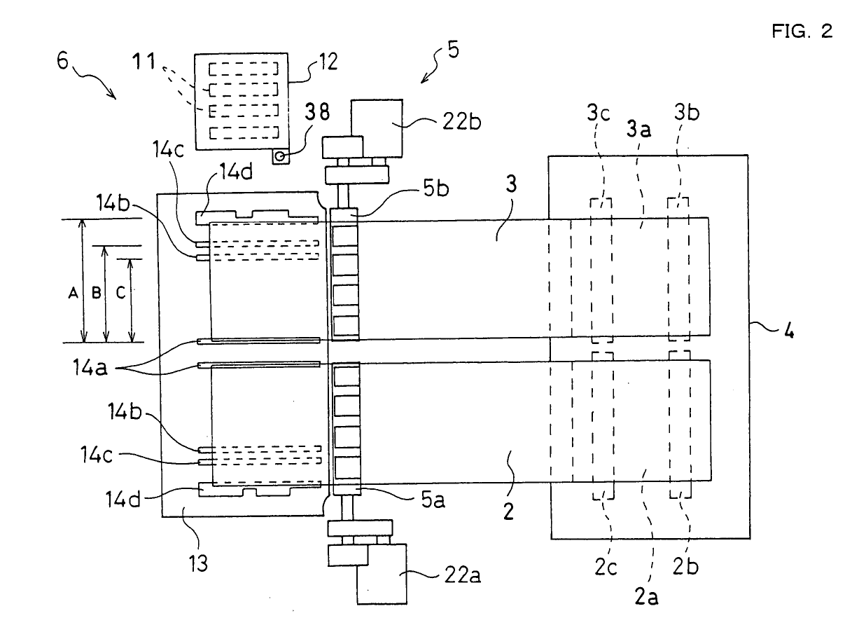

The paper magazine 4 is a substantially rectangular parallelepiped container as illustrated in FIGS. 1 and 2, and is detachable from the casing 30. The paper magazine 4 contains two roll portions 2a and 3a each formed by rolling a long paper 2 or 3 as a recording medium. The two roll portions 2a and 3a contained in the paper magazine 4 are, as illustrated in FIG. 2, arranged horizontally adjacent to each other with a predetermined distance therebetween. That is, as shown in FIG. 2, the ink-jet printer 1 can parallelly convey the two papers 2 and 3.

As illustrated in FIG. 1, each of the roll portions 2a and 3a is put on drive rollers 2b and 3b and slave rollers 2c and 3c. When the controller 20 (see FIG. 4) rotates the drive rollers 2b and 3b, the roll portions 2a and 3a are then rotated. Associated with this, the slave rollers 2c and 3c are also rotated. Like this, the papers 2 and 3 can be unwound or rewound by rotating the roll portions 2a and 3a in such a direction as to unwound or wind the papers 2 and 3.

After leading edges of the papers 2 and 3 reach the advance roller unit 5, the advance roller unit 5 conveys the papers 2 and 3 along a conveyance area sequentially to the ink-jet printing unit 6 and then to the cutting unit 8 (see FIG. 1).

As illustrated in FIG. 2, the advance roller unit 5 includes two pairs of conveyance rollers 5a and 5b as conveyance power suppliers each supplying a conveyance power independent from each other to a paper. The pairs of conveyance rollers 5a and 5b are disposed coaxially and adjacently to each other so as to correspond to the conveyance areas of the two papers 2 and 3, respectively. Each pair of the conveyance rollers 5a and 5b includes a drive roller disposed under the paper conveyance area and two press rollers disposed over the paper conveyance area to press against the drive roller. These rollers are all disposed with their axes being perpendicular to the paper conveyance direction. Each of the two papers 2 and 3 is, as pinched with the drive roller and the press roller of each pair of conveyance rollers 5a or 5b, conveyed in accordance with rotation of the drive roller.

A servomotor, which is capable of relatively high accuracy in feeding, is adopted as motors 22a and 22b (see FIG. 2) for driving the drive rollers of the pairs of conveyance rollers 5a and 5b. The motors 22a and 22b is, as will be detailed later, controlled by an individual controller 20b of the controller 20 (see FIG. 4).

As illustrated in FIG. 1, the ink-jet printing unit 6 includes printing heads 11 as image recorders, a carriage 12 as a holding member, and a platen 13. Each of the printing heads 11 has, on its lower face or on its face confronting the papers, a large number of ejection nozzles (not illustrated) that eject color inks such as yellow, magenta (purplish red), cyan (bluish green), and black. The printing heads 11 can, based on a signal from the controller 20 (see FIG. 4), eject the color inks through the large number of ejection nozzles onto a surface or an upper face in FIG. 1 of each of the papers 2 and 3 being conveyed, to thereby print desired color images on the papers.

The printing heads 11 may have ejection nozzles that eject plural color inks, color combination of which is other than the aforementioned, or may have a large number of ejection nozzles for only black ink to print monochrome images. The ink-jet printing unit 6 may be a piezo-jet type, a thermal-jet type, or any other types may be adopted, as long as ejecting liquid ink through nozzles dot by dot to print images on the papers 2 and 3.

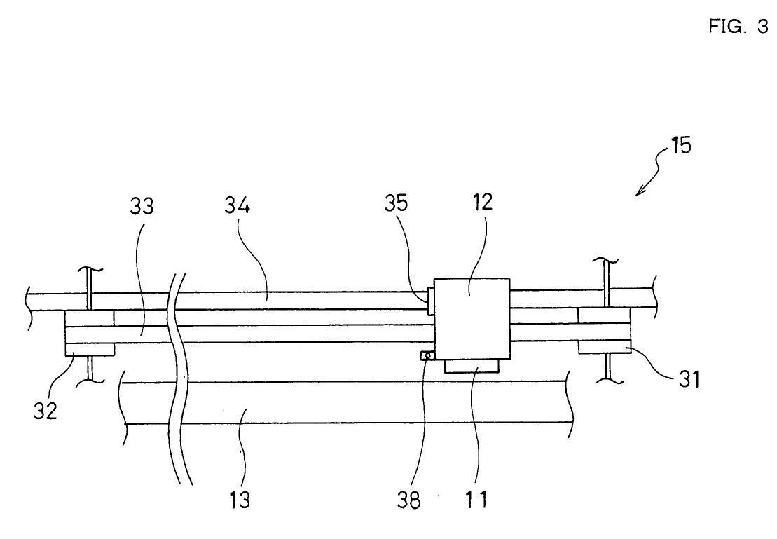

The carriage 12 holds the printing heads 11 on its lower face such that the printing heads 11 may confront the papers. The carriage 12 is, together with the printing heads 11, reciprocatable perpendicularly to the paper conveyance direction by means of a drive mechanism 15 (see FIG. 3). The printing heads 11 held by the carriage 12 eject ink onto the surfaces of the papers 2 and 3 while reciprocating with the carriage 12 perpendicularly to the paper conveyance direction. FIG. 2 illustrates that the carriage 12 is located at a parking position or a home position in case of no printing.

As illustrated in FIG. 2, a sensor 38 is attached to an edge of the carriage 12 on a side nearer a print region when the carriage is at the home position. The sensor 38 is a point sensor having a light-emitting part and a light-receiving part and capable of detecting the papers 2 and 3. The sensor 38 always detects whether or not the paper 2 or 3 exists in a region confronting the carriage 12 during reciprocations of the carriage 12. The controller 20 (see FIG. 4) can recognize a position of a paper on the basis of a detection signal fed from the sensor 38. The light-receiving part included in the sensor 38 may comprise a single light-receiving element, or plural light-receiving elements arranged adjacently to each other.

As illustrated in FIG. 3, the drive mechanism 15 for reciprocating the carriage 12 includes a drive pulley 31 driven in rotation by a motor 24 (see FIG. 4) and a slave pulley 32 driven in association with the drive pulley 31, a rotary belt 33 wrapped around the drive pulley 31 and the slave pulley 32, an encoder belt 34 extending in parallel to the rotary belt 33, an encoder 35 provided on the carriage 12 for reading detection objects on the encoder belt 34.

The drive pulley 31 and the slave pulley 32 are disposed on both sides of the print region so as to sandwich it. The rotary belt 33 extends perpendicularly to the paper conveyance direction. The carriage 12 is held on an outer face of the rotary belt 33. When, in accordance with rotation of the drive pulley 31, the rotary belt 33 rotates in the same rotation direction of the drive pulley 31, the carriage 12 moves in association with rotation of the rotary belt 33.

The drive pulley 31 is so constructed as to rotate at a predetermined angle with respect to one direction. More specifically, the drive pulley 31 rotates in one direction at a predetermined angle, then the direction of the rotation is changed so that the drive pulley 31 rotates in a reverse direction at a predetermined angle, then the direction of the rotation is changed again, and this operation is repeated. The rotary belt 33 reciprocates together with the rotations of the drive pulley 31. The carriage 12 thereby reciprocates perpendicularly to the paper conveyance direction between a vicinity of one widthwise end of the papers 2 and 3 and a vicinity of the other widthwise end of the papers 2 and 3.

The encoder belt 34 extends in parallel to the rotary belt 33, i.e., perpendicular to the paper conveyance direction. The encoder belt 34 has a lot of detection objects (not illustrated) that are arranged along a longitudinal direction of the encoder belt 34 and can be detected by the encoder 35. The encoder 35 on the carriage 12 detects the detection objects during the reciprocations of the carriage 12, and feeds a detection signal to the controller 20 (see FIG. 4). The controller 20 can recognize a position of the carriage 12 based on the detection signal.

The platen 13 has a paper supporting surface disposed on substantially the same plane as a conveyance surface for the papers 2 and 3, and serves to support the papers 2 and 3 that are so disposed as to confront the printing heads 11. Therefore, the printing heads 11 perform printing on the papers 2 and 3 disposed on the platen 13 while, in the state of confronting a surface of the platen 13, reciprocating perpendicularly to the paper conveyance direction.

As illustrated in FIG. 2, the platen 13 is provided with four pairs of ink receiving portions 14a, 14a, 14c, and 14d in a symmetrical manner with respect to a center of the platen 13 in a direction perpendicular to the paper conveyance direction. Each of the ink receiving portions 14a to 14d is a recess formed along the paper conveyance direction with a length thereof being larger than a region within which the printing heads 11 eject ink. These ink receiving portions 14a to 14d receive ink ejected outside of widthwise ends of the papers 2 and 3 in case of margin-free printing. An ink absorbing member (not illustrated) that can absorb ink is preferably arranged within each of the ink receiving portions 14a to 14d. In addition, a discharge mechanism (not illustrated) for automatically discharging ink collected within the ink receiving portions 14a to 14d may be connected to the ink receiving portions 14a to 14d.

Each of the four pairs of ink receiving portions 14a to 14d correspond to both ends, in the direction perpendicular to the paper conveyance direction, of long papers to be conveyed in parallel, the paper having three different width sizes, i.e., A, B, and C, where A>B>C. More specifically, the pair of ink receiving portions 14a is disposed at a center of the platen 13 in the direction perpendicular to the paper conveyance direction, and the pairs of ink receiving portions 14d, 14c, and 14a are disposed at positions on the platen 13 spaced apart, outwardly in the direction perpendicular to the paper conveyance direction, from the pair of ink receiving portions 14a by distances corresponding to the widths A, B, and C, respectively. Margin-free printing can thereby be performed onto a long paper having any of the three different widths A, B, and C without staining the paper conveyance surface of the platen 13 with ink. The margin-free printing may be performed also onto a long paper having a width equal to a distance between arbitrary two of the ink receiving portions 14a to 14d, not limited to the three different widths A, B, and C, without staining the paper conveyance of the platen 13 with ink.

The press roller unit 7 pinches the papers 2 and 3 that are conveyed from the ink-jet printing unit 6 to the cutting unit 8. Accordingly, printing by the ink-jet printing unit 6 and cutting of the papers 2 and 3 by the cutting unit 8 can properly be performed.

The cutting unit 8 has a movable cutting blade 8a and a fixed cutting blade 8b. The movable cutting blade 8a is disposed on the same side as the printing heads 11 with respect to the papers 2 and 3. The fixed cutting blade 8b is disposed on the opposite side of the papers 2 and 3 to the movable cutting blade 8b. Each of the movable cutting blade 8a and the fixed cutting blade 8b is a rectangular-shaped blade having a length extending over the two parallel-arranged papers 2 and 3, in order to cut, at one time, the two papers 2 and 3. The controller 20 (see FIG. 4) controls the movable cutting blade 8a to move it in such a direction as to approach to or separate from the fixed cutting blade 8b. The movable cutting blade 8a cooperates with the fixed cutting blade 8b to cut the printed papers 2 and 3, which have been conveyed to the cutting unit 8, along a widthwise direction of the papers 2 and 3. The printed papers 2 and 3 are thus cut into a predetermined length.

The discharge roller unit 9 includes pairs of discharge rollers 9a and 9b driven by the controller 20 (see FIG. 4). The discharge roller unit 9 conveys the papers 2 and 3 having cut by the cutting unit 8 to discharge them through a discharge port 30a. The pairs of discharge rollers 9a and 9b of the discharge roller unit 9 are, similarly to the pairs of conveyance rollers 5a and 5b of the advance roller unit 5, disposed coaxially and adjacently to each other, along the direction perpendicular to the paper conveyance direction, so as to correspond to the conveyance areas of the respective two papers 2 and 3 to be conveyed in parallel.

Next, a control system of the ink-jet printer 1 will be described with reference to FIG. 4.

As shown in FIG. 4, connected to the controller 20 are a motor 21 connected to the drive rollers 2b and 3b in the paper magazine 4; motors 22a and 22b connected to the two pairs of conveyance rollers 5a and 5b, respectively, in the advance roller unit 5; a driver 23 connected to the printing heads 11 in the ink-jet printing unit 6; a motor 24 connected to the drive mechanism 15 for reciprocating the carriage 12, and more specifically connected to the drive pulley 31 (see FIG. 3); a motor 28 connected to the movable cutting blade 8a of the cutting unit 8; and motors 29a and 29b connected to the two pairs of discharge rollers 9a and 9b, respectively, in the discharge roller unit 9.

The controller 20 subjects an image signal supplied from a non-illustrated input interface to a predetermined process, and then feeds, to the driver 23 connected to the printing heads 11, a print signal including image data corresponding to an image to be printed. The controller 20 also controls timings for conveying the papers 2 and 3 at the paper magazine 4, the advance roller unit 5, and the discharge roller unit 9, respectively, a timing for moving the carriage 12, a timing for ejecting ink from the printing heads 11, a timing for cutting the papers 2 and 3 at the cutting unit 8, etc.

Further, a sensor 38 and an encoder 35 are connected to the controller 20. Therefore, the controller 20 can recognize a position of the paper and a position of the carriage 12 on the basis of a signal from the sensor 38 and a signal from the encoder 35, respectively. Based on thus recognized positional relationship between the paper and the carriage 12, the controller 20 controls a timing for moving the carriage 12 and a timing for ejecting ink from the printing heads 11 such that a desired color image may be printed on the paper.

The controller 20 further comprises, as will be detailed later, a misalignment amount calculator 20a that calculates, based on the signal from the sensor 38, a misalignment amount of the paper from a given conveyance area within the print region; and an individual controller 20b that individually controls the respective two pairs of conveyance rollers 5a and 5b such that the misalignment amount may become zero.

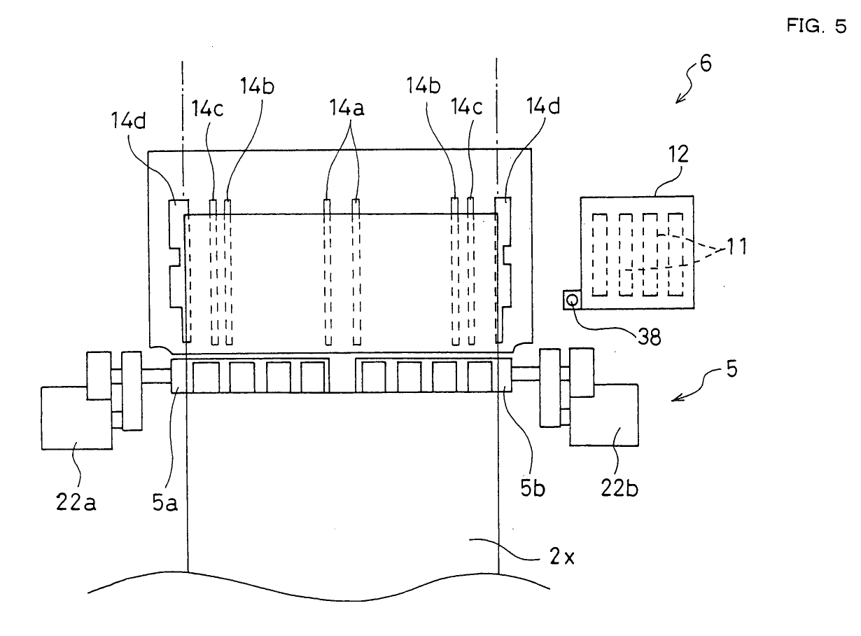

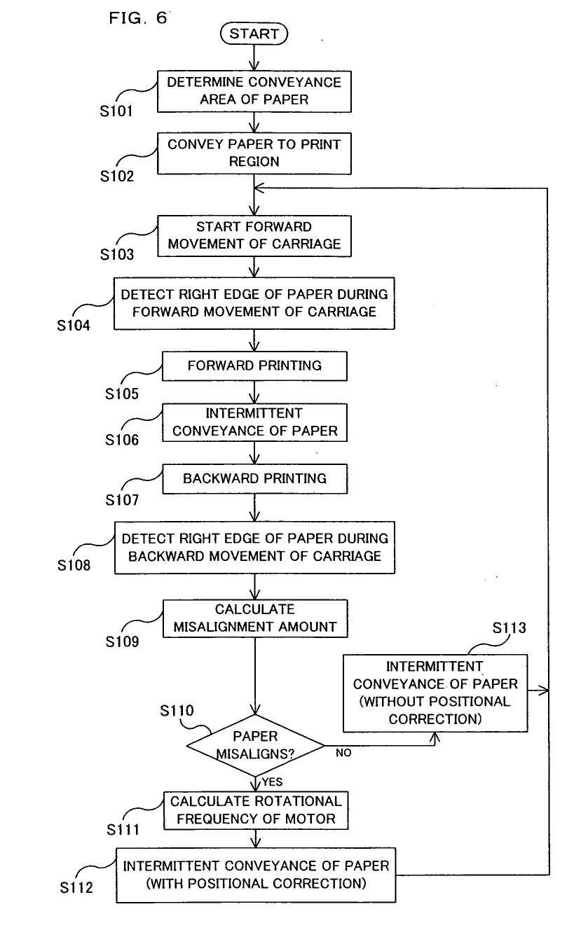

Subsequently, with reference to FIGS. 5 to 15, a description will be given to an example of printing methods in a case where the ink-jet printer 1 performs printing on a paper with a width thereof extending over the two pairs of conveyance rollers 5a and 5b (more specifically, a long paper 2x with a width thereof being equal to a distance between the pair of ink receiving portions 14d formed on the platen 13). In this case, a roll portion (not illustrated) formed by rolling a long paper 2x is contained in the paper magazine 4 illustrated in FIG. 1.

The ink-jet printer 1 is firstly set up for a specific paper size. After the setting of a paper size, the controller 20 (see FIG. 4) determines a conveyance area (Step S101). A conveyance area is preset in accordance with a print region corresponding to a paper size. In this embodiment, a paper size is set at a width size of the long paper 2x, i.e., a size equal to the distance between the pair of ink receiving portions 14d formed on the platen 13, and a given conveyance area corresponding to the paper 2x having the above-mentioned size is determined. FIG. 5 and FIGS. 7 to 14 illustrate widthwise borders of the conveyance area with alternate long and short dash lines. The controller 20 stores therein data of conveyance areas corresponding to plural sizes, and therefore papers with sizes different from the paper 2x of this embodiment are also acceptable.

The drive rollers 2b and 3b (see FIG. 1) in the paper magazine 4 rotate to thereby unwind the paper 2x from the roll portion, and the paper 2x reaches the advance roller unit 5. The paper 2x, which has reached the advance roller unit 5, is conveyed, by the pairs of conveyance rollers 5a and 5b of the advance roller unit 5, along the conveyance area determined in Step S101 to a print region confronting the printing heads 11 of the ink-jet printing unit 6 (Step S102).

When the paper 2x reaches the print region, the pairs of conveyance rollers 5a and 5b temporarily stop driving. Thus, while the paper 2x remains stationary, the carriage 12 starts moving forward, from the home position thereof i.e., the position in FIG. 5 (Step S103).

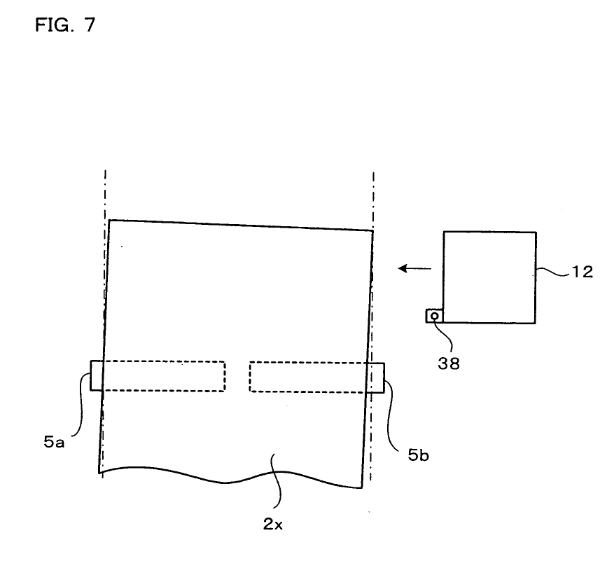

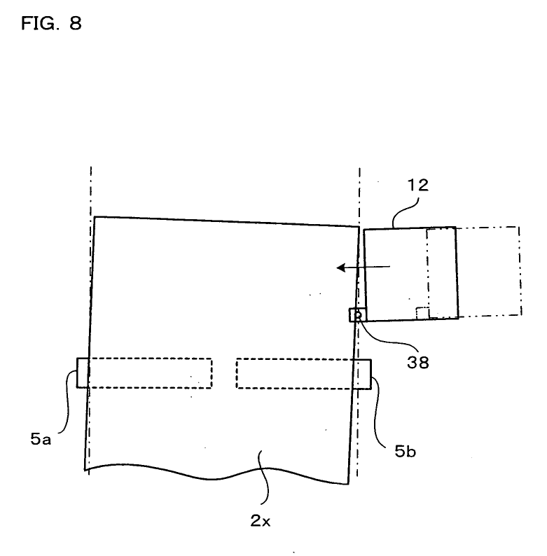

Here, assumed is a case where the paper 2x reaches the print region in a state of slightly inclining clockwise with respect to the paper conveyance direction (see FIGS. 7 to 14). FIGS. 7 to 14 illustrate only a necessary part for explaining how the carriage 12 moves and how the paper 2x is conveyed, etc., and the other parts are omitted. FIGS. 7, 13, and 14 illustrate that the carriage 12 is at the home position, and FIGS. 8 to 12 illustrate the home position with an alternate long and two short dashes line.

As illustrated in FIG. 7, after the carriage 12 starts moving forward in Step S103, the sensor 38 attached to the carriage 12 confronts a right edge of the paper 2x (see FIG. 8). At this time, the sensor 38 detects the right edge of the paper 2x (Step S104), and this detection signal is fed to the controller 20 and to the misalignment amount calculator 20a (see FIG. 4), as described above.

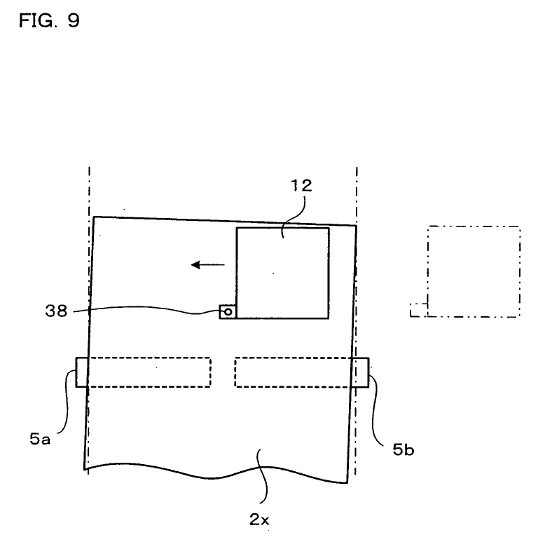

Then, as illustrated in FIG. 9, the carriage 12 continues moving forward above the paper 2x in the direction perpendicular to the paper conveyance direction. During this forward movement of the carriage 12, the printing heads 11 (see FIG. 5) held by the carriage 12 perform printing (Step S105).

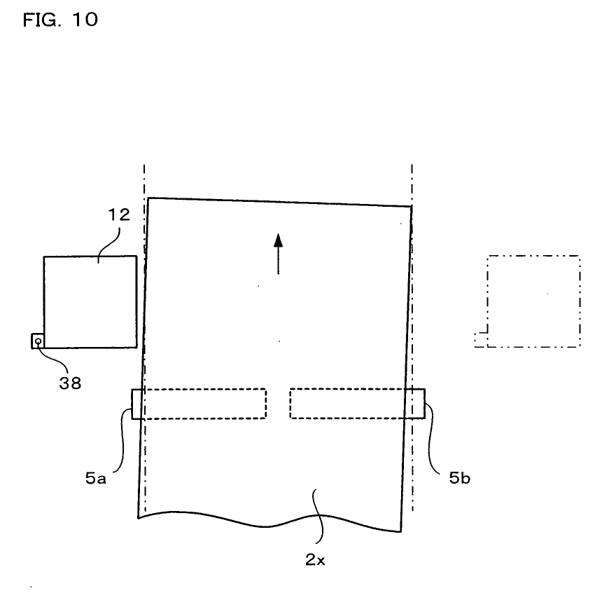

After the printing during the forward movement of the carriage 12 completes and the carriage 12 has reached a left edge of the paper 2x, the carriage 12 further moves to reach a turning position of reciprocation that is located opposite to the home position (see FIG. 10), and the carriage 12 temporarily stops at the turning position. While the carriage 12 is in a resting state like this, the pairs of conveyance rollers 5a and 5b convey the paper 2x by a predetermined, relatively small feeding amount (Step S106). The feeding amount in this conveyance is appropriately set in accordance with a pitch between ejection nozzles of the printing heads 11, the number of ejection nozzles of the printing heads 11, and a resolution of an image to be printed, etc.

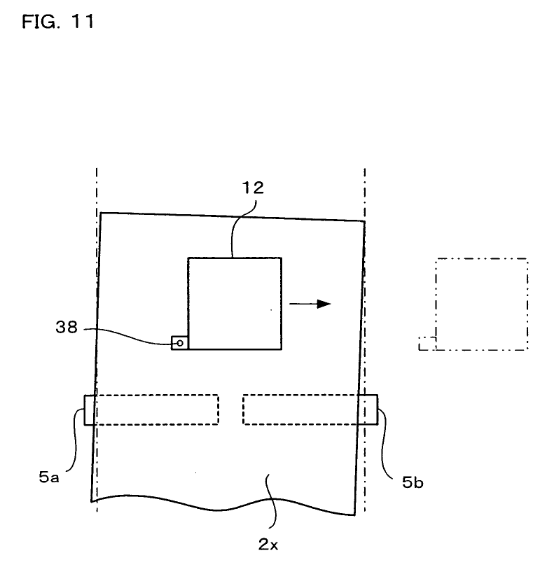

After Step S106, the pairs of conveyance rollers 5a and 5b temporarily stop driving. Thus, while the paper 2x stays stopped, the carriage 12 starts moving from the aforementioned turning position of reciprocation in a direction reverse to that of the forward movement, i.e., moving backward. During this backward movement of the carriage 12 (see FIG. 11), the printing heads 11 (see FIG. 5) perform printing (Step S107).

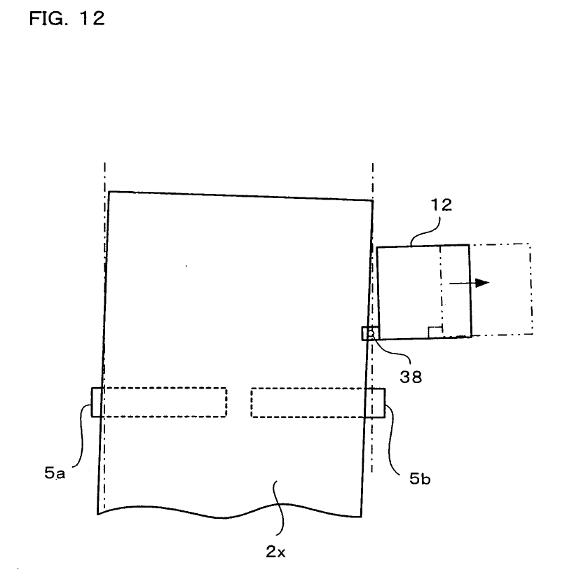

The printing during the backward movement of the carriage 12 completes, and then the sensor 38 again confronts the right edge of the paper 2x (see FIG. 12) before the carriage 12 reaches the home position. At this time, the sensor 38 again detects the right edge of the paper 2x (Step S108), and this detection signal from the sensor 38 is fed to the controller 20 and also to the misalignment amount calculator 20a (see FIG. 4).

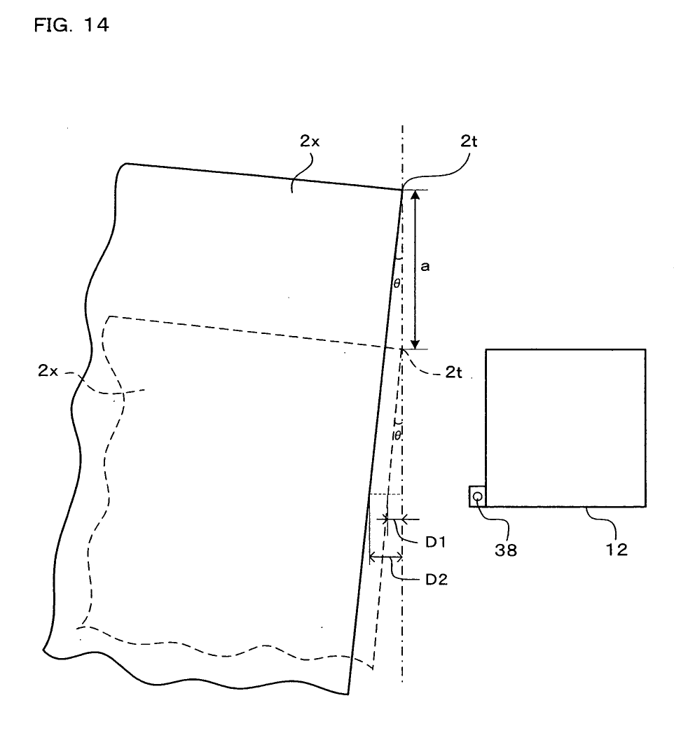

Here, with reference to FIG. 14, there will be described an example of how the misalignment amount calculator 20a calculates a misalignment amount. A “misalignment amount” includes a displacement in the direction perpendicular to the paper conveyance direction, and an inclination angle with respect to the paper conveyance direction. In FIG. 14, a part of the paper 2x of FIG. 7 around the right edge thereof is illustrated with a broken line, and a part of the paper 2x of FIG. 10 around the right edge thereof is illustrated with a solid line.

Here, there is assumed that the paper 2x reaches the print region in the state of slightly inclining clockwise with respect to the paper conveyance direction as described above, and that an inclination angle θ of the paper 2x with respect to the paper conveyance direction does not change before and after the paper 2x is conveyed in the subsequent Step S106. This is because a feeding amount of the paper in this conveyance is relatively small. Accordingly, an inclination angle θ of the paper 2x during forward printing, as illustrated with the broken line in FIG. 14, is equal to an inclination angle θ of the paper 2x during backward printing, as illustrated with the solid line. There is further assumed that, in the print region, a right leading edge of the paper 2x is always on the boundary line of the given conveyance area, and that the paper 2x moves parallelly in the paper conveyance direction by being intermittently conveyed.

The misalignment amount calculator 20a firstly calculates differences, in the direction perpendicular to the paper conveyance direction, between a right edge of the given conveyance area and the right edges of the paper 2x detected in respective Steps S104 and S108 in the forward and backward movements of the carriage 12. That is, the misalignment amount calculator 20a firstly calculates displacements D1 and D2, where D2>D1>0, in the direction perpendicular to the paper conveyance direction. Under the aforementioned assumptions, provided that the feeding amount in the intermittent conveyance is defined as a, the inclination angle θ of the paper 2x with respect to the paper conveyance direction is calculated from an equation “0=tan⁻¹((D2−D1)/α)”. According to this equation, when values of the displacements D1 and D2 in the forward movement and the backward movement of the carriage 12 are both zero or the same value, the inclination angle θ of the paper 2x is calculated at zero. In this example, however, the displacements D1 and D2 never have the same value, because it is assumed that the right leading edge of the paper 2x is always on the boundary line of the given conveyance area. Accordingly, the inclination angle θ is calculated at zero only when both of the displacements D1 and D2 are zero.

When the inclination angle θ calculated in this way has a value other than zero, the controller 20 judges that the paper 2x misaligns from the given conveyance area (Step S110; YES). This situation is explained in this example as shown in FIG. 14.

Then, the individual controller 20b of the controller 20 calculates appropriate rotational frequencies of the motors 22a and 22b (see FIG. 4) connected to the respective two pairs of conveyance rollers 5a and 5b, for correcting, by means of one intermittent conveyance, the displacement in the direction perpendicular to the paper conveyance direction and the inclination angle θ with respect to the paper conveyance direction to zero (Step S111). The rotational frequencies of the motors 22a and 22b determine rotational frequencies of the respective pairs of conveyance rollers 5a and 5b, and also conveyance powers to be supplied to the paper 2x by the respective pairs of conveyance rollers 5a and 5b.

In a case where, like in this example, the paper 2x inclines clockwise with respect to the paper conveyance direction with the right leading edge thereof being kept on the boundary line of the given conveyance area, the rotational frequencies of the motors are determined such that, for example, the right pair of conveyance rollers 5b may have a conveyance speed slightly higher than that of the left pair of conveyance rollers 5a for a predetermined time period. On the other hand, in a case where the paper 2x inclines counterclockwise with respect to the paper conveyance direction with the right leading edge thereof being kept on the boundary line of the given conveyance area, the rotational frequencies of the motors are determined such that, for example, the left pair of conveyance rollers 5a may have a conveyance speed slightly higher than that of the right pair of conveyance rollers 5b for a predetermined time period.

In a case where the right leading edge of the paper 2x is not kept on the boundary line of the given conveyance area, the inclination angle θ with respect to the paper conveyance direction is zero, and the displacement in the direction perpendicular to the paper conveyance direction is not zero; the rotational frequencies of the motors for driving the two pairs of conveyance rollers 5a and 5b are determined such that the displacement may become zero with the inclination angle θ being kept at zero. When the paper 2x deviates left in the direction perpendicular to the paper conveyance direction, i.e., in case of the displacement D2>0 in FIG. 14, for example, the rotational frequencies of the motors are determined such that, at first, the left pair of conveyance rollers 5a may have a conveyance speed slightly higher than that of the right pair of conveyance rollers 5b for a predetermined time period, and then the right pair of conveyance rollers 5b may have a conveyance speed slightly higher than that of the left pair of conveyance rollers 5a for a predetermined time period. On the other hand, when the paper 2x deviates right in the direction perpendicular to the paper conveyance direction, i.e., in case of the displacement D2<0 in FIG. 14, for example, the rotational frequencies of the motors are determined such that, at first, the right pair of conveyance rollers 5b may have a conveyance speed slightly higher than that of the left pair of conveyance rollers 5a for a predetermined time period, and then the left pair of conveyance rollers 5a may have a conveyance speed slightly higher than that of the right pair of conveyance rollers 5b for a predetermined time period. The above-described control may otherwise be applied also to a case where the right leading edge of the paper 2x is not kept on the boundary line of the given conveyance area, the inclination angle θ with respect to the paper conveyance direction is not zero, and the displacement in the direction perpendicular to the paper conveyance direction is not zero. In this case, the rotational frequencies of the motors are determined such that both the inclination angle and the displacement may become zero.

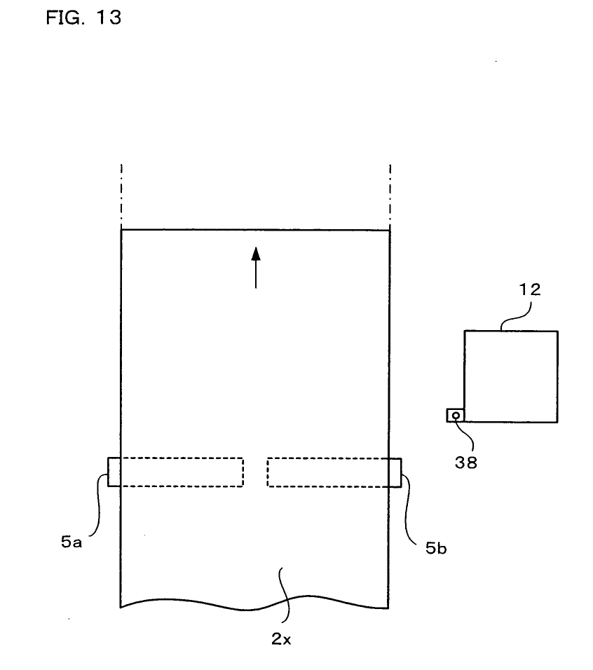

When the carriage 12 further moves to reach the home position again, the carriage 12 temporarily stops moving, and, at this point, the pairs of conveyance rollers 5a and 5b are driven by the motors 22a and 22b that rotate at the aforementioned rotational frequencies. This allows the pairs of conveyance rollers 5a and 5b to convey the paper 2x by a predetermined feeding amount, and, in accordance with this conveyance, the inclination angle θ becomes smaller (Step S112). Regarding the paper 2x after Step S112, as illustrated in FIG. 13, both the displacement in the direction perpendicular to the paper conveyance direction and the inclination angle with respect to the paper conveyance direction become zero. That is, the misalignment of the paper 2x is almost removed.

Thereafter, returning to Step S103, the carriage 12 starts moving forward again, and the above-described operations are repeated.

When the misalignment amount calculator 20a calculates the inclination angle θ at zero, the controller 20 judges that the paper 2x does not misalign from the given conveyance area (Step S110; NO) because it is assumed in this example that the right leading edge of the paper 2x is always on the boundary line of the given conveyance area. In this case, a specific rotational frequency of each motor is not calculated, and, similarly to Step S106, the paper 2x is conveyed by a predetermined feeding amount without any positional correction (Step S113). Thereafter, returning to Step S103, the carriage 12 starts moving forward again, and the above-described operations are repeated.

As described above, according to the ink-jet printer 1, the sensor 38 detects the paper 2x, the misalignment amount calculator 20a calculates, based on the detection signal from the sensor 38, the misalignment amount of the paper 2x from the given conveyance area (i.e., the inclination angle θ with respect to the conveyance direction in the above description), and the individual controller 20b individually controls the respective two pairs of conveyance rollers 5a and 5b such that the misalignment amount may become zero. Therefore, even when the single paper 2x is conveyed by the two pairs of conveyance rollers 5a and 5b, the paper 2x can effectively be restrained from misaligning from the given conveyance area. Moreover, this can relieve at least one of various problems caused by a misalignment of a paper, the problems such as deterioration in printing quality, a difficulty in enlarging the print region, and an adherence of ink onto the paper conveyance surface of the platen 13 in case of margin-free printing because of the edges of the paper 2x being located at positions not corresponding to the ink receiving portions 14a to 14d formed on the platen 13, etc.

According to this embodiment, further, even when a servomotor, which is easily affected by a load of the paper 2x, is adopted as the motors 22a and 22b for driving the drive rollers of the pairs of conveyance rollers 5a and 5b, misalignment can effectively be restrained. Therefore, such an advantage of a servomotor as high accuracy in feeding can be obtained.

Still further, since the sensor 38 is attached to the carriage 12 reciprocatable in the direction perpendicular to the conveyance direction of the paper 2x in order to detect the edge of the paper 2x in the direction perpendicular to the conveyance direction, a relatively small-sized point sensor, not a large-sized one such as a line sensor, may solely be used as the sensor 38. Costs of the ink-jet printer 1 can therefore be reduced.

The pairs of conveyance rollers 5a and 5b are controlled such that the paper 2x may be kept stopped during a printing operation of the printing heads 11. Accordingly, the problem of deterioration in printing quality can further effectively be relieved.

Still further, the ink-jet printer 1 comprises the detachable paper magazine 4 for containing a roll portion formed by rolling a long paper, from which the long paper is unwound to be conveyed out. In such a construction, once a paper misaligns, a misalignment amount becomes larger as a rear end of the paper approaches. According to this embodiment, however, a misalignment of the paper 2x is removed after every reciprocation of the carriage 12, thereby restraining misalignments over a full length of the long paper 2x.

According to this embodiment, further, the paper 2x can be restrained from misaligning in the same manner as described above, even when the paper 2x inclines with respect to the conveyance direction thereof because of some trouble such as an improper mounting of the paper magazine 4 within the casing 30, etc.

According to this embodiment, further, a misalignment of the paper 2x caused by wobbles of an apparatus as a whole by reciprocations of the carriage 12 can also be restrained in the same manner.

In the above-described embodiment, the sensor 38 detects the right edge of the paper 2x both in the forward movement and in the backward movement of the carriage 12. However, this is not limitative, and the sensor 38 may detect the right edge of the paper 2x in either one of the forward movement or the backward movement of the carriage 12. When, for example, the right edge of the paper 2x is detected only in the forward movement of the carriage 12, a misalignment amount of the paper 2x from the given conveyance area may be calculated based on a detection signal in this forward movement of the carriage 12 and on a detection signal in the last forward movement of the carriage 12.

In the above-described embodiment, after every reciprocation of the carriage 12, a misalignment amount of the paper 2x is calculated and, if any misalignment is found, a position of the paper 2x is corrected. However, this is not limitative. A misalignment amount of the paper 2x may be calculated and, if any misalignment is found, a position of the paper 2x may be corrected, for example, in every forward or backward movement of the carriage 12 or in every several reciprocations of the carriage 12.

Although, in the above-described embodiment, the sensor 38 detects the right edge of the paper 2x, both the right and the left edges may be detected or only the left edge may be detected.

In Step S111 of the above embodiment, the rotational frequencies of the motors are calculated such that the misalignment amount (i.e., the inclination angle θ with respect to the conveyance direction in the above description) may become zero by means of one intermittent conveyance. However, the rotational frequencies of the motors may be calculated such that the misalignment amount may, at least, become reduced by means of one intermittent conveyance.

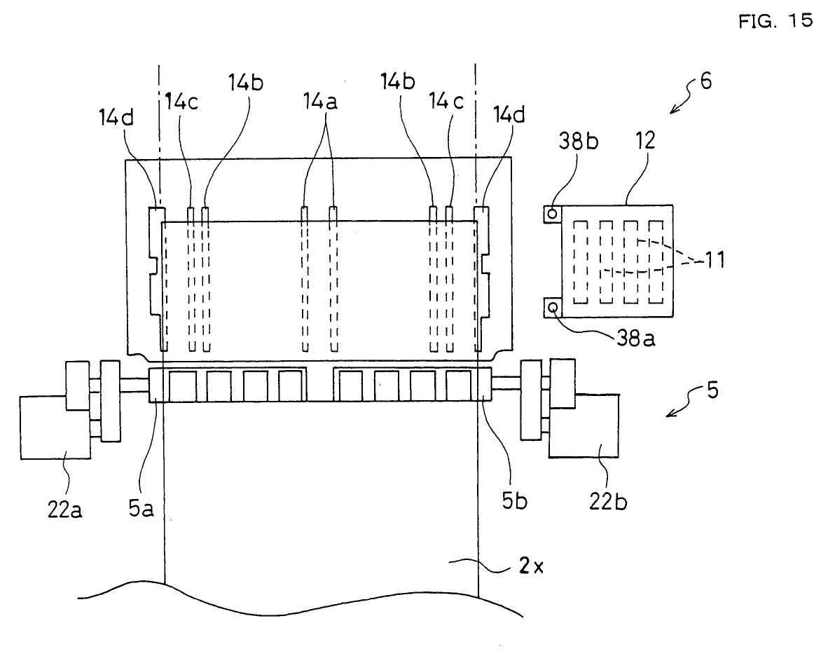

Although, in the above-described embodiment, one point sensor 38 is attached to the carriage 12 that reciprocates perpendicularly to the paper conveyance direction, a sensor is not limited thereto and may arbitrarily be changed in type and arrangement as long as the sensor can detect a paper. As illustrated in FIG. 15, for example, two point sensors 38a and 38b may be arranged, in parallel to the conveyance direction of the paper 2x, at an edge of the carriage 12 on a side nearer the print region when the carriage 12 is at the home position. In this case, for example, a difference in timing of detecting the right edge of the paper 2x between one sensor 38a and the other sensor 38b can be used to detect an inclination angle of the paper 2x with respect to the. conveyance direction even in a single forward or backward movement of the carriage 12. That is, a use of the single point sensor 38 as in the above embodiment requires one reciprocation of the carriage 12 in order to obtain an inclination angle θ of the paper, whereas a use of the two point sensors 38a and 38b enables an inclination angle θ of the paper to be obtained in every forward or backward movement of the carriage 12. Thus, a misalignment amount of the paper 2x is controlled to become zero or to become reduced every time an inclination angle θ is calculated, so that a misalignment amount of the paper 2x can be prevented beforehand from becoming excessively large as the conveyance proceeds.

In addition, the sensor may not be attached to the carriage 12. For example, on the platen 13, a plurality of sensors or a line-shaped sensor may be arranged perpendicularly to the paper conveyance direction.

Moreover, in the above-described embodiment, the given conveyance area is determined prior to starting to convey the paper. However, the conveyance area may be determined based on a state where the paper has been conveyed and the leading edge of the paper has reached the print region. In this case, for example, a path obtained by extending, in parallel to the paper conveyance direction, two points at which both corners on the leading edge of the paper are located is defined as the conveyance area.

Although the above-described embodiment adopts a construction in which printing is performed while the paper kept stopped, a construction in which printing is performed while the paper is being conveyed without being stopped may also be adopted.

Although the above-described embodiment illustrates that printing is performed onto the long paper that has been unwound from the roll portion and then conveyed, cut papers with a predetermined length may be conveyed to be printed thereon.

Further, the ink-jet printer 1 of the above embodiment comprises two pairs of conveyance rollers 5a and 5b corresponding to the conveyance areas for the two papers 2 and 3, respectively. However, this is not limitative, and the ink-jet printer 1 may comprise three or more pairs of conveyance rollers so arranged as to correspond respective conveyance areas in order to supply conveyance powers independent from each other to three or more papers.

As the conveyance power supplier that supplies a conveyance power to a paper, there may be adopted, other than the pair of conveyance rollers 5a or 5b of the aforementioned embodiment, a conveyer belt, etc., that supports a paper thereon and convey the paper. In this case, a plurality of conveyer belts are provided to correspond respective papers to be conveyed in parallel to each other.

An application of the present invention is not limited to a so-called serial-type printer in which, as in the above embodiment, the printing heads 11 eject ink while the carriage 12 reciprocates perpendicularly to the paper conveyance direction to thereby perform printing. The present invention is applicable also to a line-type printer that performs printing by ejecting ink from a fixed printing head. Further, the present invention is not limited to an ink-jet printer but applicable to various apparatuses, as long as the apparatus can record image on a recording medium. As an example of such apparatus there may be mentioned a photograph processing apparatus that subjects a photographic paper as a recording medium to an exposure process to thereby record an image thereon. When the present invention is applied to a photograph processing apparatus, either of an analog exposure system and a digital exposure system may be acceptable.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be-made without departing from the spirit and scope of the invention as defined in the following claims.

What is claimed is:

1. An image recording apparatus comprising:
an image recorder that records an image on a recording medium;
a conveyance mechanism having plural conveyance power suppliers each supplying a conveyance power independent from each other to a recording medium, the conveyance mechanism being capable of conveying, to a region confronting the image recorder, a recording medium with a width thereof extending over the plural conveyance power suppliers;
a sensor that detects a recording medium being conveyed by the conveyance mechanism;
a misalignment amount calculator that calculates, based on a detection signal fed from the sensor, a misalignment amount of a recording medium from a given conveyance area; and
an individual controller that individually controls the respective plural conveyance power suppliers such that the misalignment amount may become smaller.

2. The image recording apparatus according to claim 1, wherein:
each of the plural conveyance power suppliers is individually driven by a servomotor; and
the individual controller individually controls a rotational frequency of the servomotor.

3. The image recording apparatus according to claim 1, wherein:
each of the plural conveyance power suppliers includes a pair of conveyance rollers capable of pinching and conveying a recording medium; and
the individual controller individually controls a rotational frequency of the pair of conveyance rollers.

4. The image recording apparatus according to claim 1, further comprising:
a holding member that holds the image recorder such that the image recorder may confront a recording medium, and
a drive mechanism that reciprocates the holding member in a direction substantially perpendicular to a conveyance direction of a recording medium;
wherein the sensor is attached to the holding member, and detects an edge of a recording medium in a direction perpendicular to the conveyance direction of the recording medium.

5. The image recording apparatus according to claim 4, wherein the sensor is a single point sensor.

6. The image recording apparatus according to claim 4, wherein the sensor comprises plural point sensors arranged substantially in parallel to the conveyance direction of a recording medium.

7. The image recording apparatus according to claim 1, wherein the individual controller so controls the plural conveyance power suppliers that a recording medium may be kept stopped while the image recorder is recording an image.

8. The image recording apparatus according to claim 1, further comprising a detachable roll-portion container for containing a roll portion formed by rolling a long recording medium,
wherein the conveyance mechanism is capable of conveying the recording medium unwound from the roll portion.

9. An image recording method comprising the steps of:
conveying a paper to a region confronting an image recorder that records image on a recording medium, by means of plural conveyance power suppliers each supplying a conveyance power independent form each other to a recording medium;
detecting, with a sensor, a recording medium in a region confronting the image recorder;
calculating, based on a detection signal fed from the sensor, a misalignment amount of a recording medium from a given conveyance area;
intermittently conveying a recording medium as the plural conveyance power suppliers are individually controlled such that the misalignment amount may become smaller; and
recording an image, by means of the image recorder, on a recording medium having conveyed by the plural conveyance power suppliers.
